(19) United States
(12) Patent Application Publication
(10) Pub. No.: US 2025/0033064 A1
(43) Pub. Date: Jan. 30, 2025

(54) ROLLER MACHINE WITH A RADAR MONITORING UNIT, RADAR MONITORING UNIT FOR A I ROLLER MACHINE AND A METHOD HERETO

(71) Applicant: INDURAD GMBH, Aachen (DE)

(72) Inventors: Reik Winkel, Aachen (DE); Stephan W. Kirsch, Western Australia WA (AU)

(21) Appl. No.: 18/716,680

(22) PCT Filed: Dec. 7, 2021
(86) PCT No.: PCT/EP2021/084615

§ 371 Date: Jun. 5, 2024

(51) Int. Cl. B02C 25/00; B02C 4/28; G01S 13/88; B02C 4/02; G01S 13/90

(52) U.S. Cl. CPC B02C 25/00; B02C 4/28; G01S 13/88; B02C 4/02; G01S 13/90

(57) ABSTRACT

A roller machine has at least one roll featuring a plurality of crushing elements and a plurality of edge protection elements on its outer surface. In between the crushing elements, an autogenous layer is typically established. At least one radar unit is operable to emit a radar beam onto the outer surface of the roll to monitor the state and the condition of the crushing elements, the edge protection elements, the autogenous layer and the outer surface of the roll by means of a measurement by the radar beam reflected at least by the crushing elements, the edge protection elements, the autogenous layer and the outer surface of the roll. A method for monitoring the state and the condition of a roller machine and to a monitoring unit for implementation into a roller machine are disclosed.

### CROSS-REFERENCE TO RELATED APPLICATIONS

This application is the U.S. National Stage of PCT/EP2021/084615 filed on Dec. 7, 2021, the entire content is incorporated herein by reference in its entirety.

### FIELD OF THE INVENTION

The present invention relates to machines using rollers for compaction and/or crushing with at least one roll, and the roll features a plurality of crushing elements, namely studs or buttons, on its outer surface.

EP 3 393 667 B1 discloses a comminuting machine which is embodied as a cone crusher, in which the material which must be comminuted is guided to a gap formed between at least one wear layer applied to a component part of the comminuting machine and a counter-surface. The extend of said gap is varying when the at least one wear layer progressively wears. A radar antenna orientated towards the associated counter-surface is assigned for determining the wear occurring at the wear layer and/or for determining the respectively applicable extend of the gap between the wear layer and the counter surface, and the radar antenna comprises an antenna region and a wear part assigned to at least that region of the wear layer which is provided for permissible wear, said wear part becoming shorter with the progressive wear of the wear layer.

The measuring principle which is applied for monitoring the wear of the wear layer in said cone crusher is elaborative in the design and the installation of the radar antenna. The radar antenna is also exposed to a wear because the radar antenna comes into contact with the comminuting material to be crushed. Another disadvantage is, that the measurement is s just a spot measurement and is not suited for a whole surface measurement.

### BACKGROUND OF THE INVENTION

It is an object of the present invention to provide a roller machine with at least one roll having a plurality of crushing and/or compaction elements on its outer surface, whereas it is desired to monitor the wear of the crushing rolls and the crushing elements on the surface of the crushing rolls, in particular the state and thus the condition of the crushing elements should be monitored. As a main objective the monitoring unit should neither come into contact with the roller machine feed material nor with the crushing and edge protection elements and the monitoring unit should be as robust as possible. Further the objective is to have a fully sealed unit measuring through a protection enclosure which does not require rubber lips for sealing and/or purge air for maintaining a clean sensor lens.

This object is achieved by a roller machine as taught in the present invention. Advantageous embodiments of the inventive system are disclosed herein.

### SUMMARY OF THE INVENTION

The invention discloses the technical teaching that at least one radar unit is provided, and the radar unit is performed to emit a radar beam onto the outer surface of the roll, to monitor the state of the crushing elements on the outer surface of the roll by means of a measurement of the radar beam reflected at least by the crushing elements.

It is the core idea of the invention to apply a radar unit in at least one circumferential position of the roll, which position is spaced apart from the crushing gap, whereas the crushing gap is defined by the circumferential position on the roll where the material to be crushed is in direct contact with the outer surface of the crushing roll. The at least one radar unit is positioned spaced apart to the crushing gap.

The roller machine for crushing or compaction feed material relates to all machine types having at least one roll with crushing elements on the outer surface of the roller. Accordingly, all kinds of autogenous crusher, collapsing crusher, compacting machines like for briquetting and similar are covered by the roller machine according to the invention. The crushing elements in the sense of the present wording also cover elements for compaction, thus the elements also enclose and/or are directed to compaction elements.

When the radar unit is spaced apart from the crushing gap, no roller machine feed or discharge material causes wear of or any negative effect onto the radar unit, and the radar antenna respectively. The roll forms a cylindrical rotating body having a cylinder length, and the radar unit features an extension which is adopted to the length of the cylinder body of the roll. The radar unit is positioned in a certain distance to the outer surface of the roll with a longitudinal extension, in such a way that the gap between the radar unit and the outer surface of the roll is similar across the entire cylinder length. This leads to the advantage that at least all crushing elements, which are applied over the total length of the cylinder body, forming the roll being monitored, in other words from roller edge to roller edge, which forms the width of the roll, respectively.

The radar unit comprises a radar antenna which is directed to the surface of the roll, and the main direction of the radar antenna and the radar beam is directed preferably perpendicular onto the surface of the roll. The radar beam can also be directed towards the roll in a flat angle. The monitoring of the state of the crushing elements is performed during the operating of the roller machine and thus while the rolls are rotating in their rotating axis. Due to the propagation of the radar beam, which extension is adopted to the length of the cylindrical body of the roll, and due to the rotating movement of the roll about an axis direction, each of the crushing elements is moved through the radar beam during one full rotation of the roll. By the measurement of the radar beam, which is reflected by the crushing elements as well as reflected by the outer surface of the roll, it is possible to provide an information about the state and the condition of each of the crushing elements.

In particular, when both, the crushing elements and simultaneously the outer surface of the roll are measured, either simultaneously or in a periodic sequence one to another, it is possible to provide information about the condition of the crushing elements by a comparison of the distance between the top of the impact elements and the surface of the roll, according to two measurement levels, it can be compared and the length of the crushing elements protruded from the surface of the roll can be determined. Thus, the condition of the crushing elements and the edge protection elements can be monitored in the height and the formation, but also the condition of the surface of the roll and the formation or existence of an autogenous layer formed by the crushed feed material can be monitored. Both monitoring processes can be performed simultaneously.

A central advantage is that the radar unit can be a fully sealed measuring unit through a protection enclosure which does not require rubber lips for sealing and/or purge air for maintaining a clean sensor lens, which would be required with many optical instruments like lasers or cameras.

According to another embodiment, the roller machine features a first roll and a second roll, whereas a first radar unit is provided to direct a first array of radar beams onto the outer surface of the first roll and a second radar unit is provided to direct a second array of radar beams onto the outer surface of the second roll. As a result, each of the impact elements of the first roll as well as of the second roll can be monitored by means of the radar unit. In other words, each of the rolls has a dedicated radar unit, and each radar unit provides an information about the condition and the state of the crushing and the edge protection elements on the outer surface of each of the crushing rolls and/or the condition including the formation or existence of an autogenous layer of the outer surface of each of the crushing rolls itself.

In between the first crushing roll and the second crushing roll the crushing gap is formed as described above, whereas the first radar unit and/or the second radar unit is positioned spaced apart from the gap. In particular and according to other advantageous embodiment, the roller machine features a crusher frame, in which the at least one roll is rotatable received, whereas the first radar unit and/or the second radar unit is preferably and as an example only arranged within the crusher frame in a top position 90° rotated to the crushing gap or, as an alternative, at a lateral outer side diametral to the crushing gap in between both crushing rolls. Of course, the radar unit can be arranged at any circumferential position of the roll, but preferably in a position where the radar unit is minimal impacted by bulk material and/or where the radar unit can be maintained in a convenient and beneficial manner.

When the radar unit is applied at the top side of the frame or in a lateral outer position, no crusher feed material comes into contact with the radar unit. Accordingly, it is a huge advantage of applying a radar unit, in particular compared to a laser measuring system, that the rough conditions do not affect the measuring principle and the measuring accuracy, because the radar beam and the technological conditions for operating the radar beam can be adapted to only monitor the metallic surface of the outer surface of the rolls, the autogenous layer and the crushing elements as well as the edge protection elements, respectively. Dust in the surrounding does not have any influence or, in the case of a high amount of dry dust, only a very small effect on the condition monitoring of said crushing elements and/or the surface of the roll, respectively.

The crushing elements form stud elements, which are embedded into the roller body, and which preferably protrude vertically out from the surface of the roll body, whereas the at least one radar unit is formed to measure the presence and/or the remaining height of the stud elements extending above the surface, in particular beginning from a new condition to a state, in which the stud elements are worn. When the roller machine is used for hard and brittle feed material which has to be crushed or compacted, it is known that the crushing elements can be subject to chipping effects or can be lost completely above of the surface of the roll due to breakage.

Crushing elements can be made of a sinter material, e.g., by tungsten carbide material, and parts of the sinter material can break off in particular in the head area, so pitting areas arise in the crushing elements. The inventive radar unit can measure in a millimetre-range, and it is possible to detect said pittings and breakouts in the crushing elements. When the radar unit monitors the condition of the crushing elements, this information can be documented and stored in a storage unit, and thus it is possible to monitor other wear of the crushing elements over the operating time of the roller machine.

Accordingly, it is possible to calculate the point of time, in which the crushing elements must be replaced by new elements, based on the radar measurements and by means of specific algorithms, e.g., depending on the number of damaged or broken crushing elements related to the total number of applied crushing elements per roll and which change over time. It is then possible to determine the point in time in the future, when the roll must be exchanged against a new roll, whereas the monitoring of the crushing elements as well as the surface of the roll continues, whilst the machine is in operation.

According to another aspect of the invention a so-called autogenous layer can be measured, which results from the crushing process. The autogenous layer can occur as an incrustation in between the crushing elements on the surface of the roll. It typically forms a strong layer, which can hardly be removed during operation of the roll. Relating to this aspect of the invention, the at least one radar unit is formed to measure the thickness of the autogenous layer above the surface of the roll. The thickness of the autogenous layer can be monitored by the radar unit and the radar unit can provide information about the condition of the autogenous layer. The measurement of the autogenous layer can be performed simultaneously with the monitoring of the condition and the states of the crushing elements, the edge protection elements as well as with the condition of the outer surface of the roll.

The at least one radar unit features a radar type that uses a monostatic, a bistatic or a multistatic antenna layout. Moreover, the at least one radar unit is operated in an FMCW modulation or a pulse modulation or a so-called code multiplex system. According to yet another embodiment, the at least one radar unit teaches a standard signal processing and optional a variant of synthetic aperture radar (SAR), that is specifically adapted to the roll surface of the crusher. In an optional additional adaption at least two of the SAR processing systems with radars measuring different aspect angles, interferometric processing are realized.

A Synthetic Aperture Radar (SAR) is not an independent radar device (like monostatic, . . . ), but a pure measurement data processing system in conjunction with a radar which calculates many neighboring strongly overlapping single measurements. The result is a contrast image of the development (in the plane) of the surface. For this, one or more of the aforementioned radars must be arranged in a certain orientation to the roll surface, typically in a flat angle, but in any case, not perpendicular. Whereas the simplest evaluation is to simply measure perpendicular to the surface and record point by point.

Both times it concerns imaging procedures, where SAR by itself does not allow to determine an altitude in a measuring direction. The whole system is more like a photograph. The disadvantage can be compensated by simultaneously recording the surface from two different angles, and in this way an interferometric image is created, which allows an evaluation of the height differences.

According to yet another aspect, the first radar unit and/or the second radar unit forms a radar array sensor built out of multiple monostatic, bistatic or multistatic radar sensors with a linear actor to scan the radar beam across the surface of the roll in axial direction, in particular across the entire width of the roll, while the surface is circumferentially moved due to the axial rotation of the roll.

As a result of any of the described aspects, the entire number of crushing elements on/within the surface of the cylindrical roll is monitored, as each of the crushing elements is moved through the radar beam per revolution of the roll and thus each element is monitored by the radar beam and is in particular documented in a control unit, which is in particular and/or additionally formed as a processing unit. In one preferred embodiment, a number of radar antennas are applied in a row one next to the other along the axis direction of the roll, to form the radar array using one of the previous described radar types.

In another preferred embodiment, a number of radar antennas are applied in at least two rows with along the axis direction of the roll, to allow interferometric processing. An additional preferred embodiment with one or many of the named radar types is mounted next to the roll at the side of the crusher assembly allowing an open view along the roll axis oriented in a flat angle range towards the roll. Due to the roll length optional from both sides with separate embodiments can be used.

The at least one radar unit can be received within the crusher frame with a maintenance removing system, by which the radar unit can easily be removed out of the crusher frame, in particular by a sliding movement. The sliding direction of the sliding movement is advantageously performed parallel to the axis direction of the roll, but another preferred sliding direction is vertical to the side direction.

The present invention is also directed to a method for monitoring the condition of a roller machine as described above, whereas the method comprises of at least the following steps: Providing a control unit, whereas the control unit controls the at least one radar unit, implementing the geometric data of the crushing elements on the outer surface of the roll, whereas the geometric data relate to crushing elements in good and/or new condition and measuring the condition of the crushing elements by measuring the radar beam reflected at least by the crushing elements to monitor the condition of the crushing elements. As a result of the method, an information can be provided, which contains the condition of each of the crushing elements, and the condition of the crushing elements base on the geometric contour of the crushing elements, and breakouts can be detected as well as the entire failure of certain crushing elements. The same monitoring method is applicable for the edge protection elements and/or the surface of the roll, which carry the crushing elements.

The method also comprises the step of providing a control unit, which control unit controls the at least one radar unit for mapping the geometric data of the multiple of crushing elements while the roller machine is in use and the at least one roll is turning and followed by the step of comparing the measured geometric data of the multiple crushing elements with the geometric data of the crushing elements in their good and/or new condition and providing an assessment of the condition of the crushing elements based on a deviation of the current measured geometric data relating to the geometric data of new crushing elements.

The measuring of the condition of the crushing elements can also be performed by a displacement of the radar beam during the turning of the roll, whereas the displacement is performed e.g., by a linear actor in a displacement direction, which is aligned with the axis direction of the roll. By a simultaneously scanning and turning of the surface of the roll the entire circumferential development of the outer surface of the roll can be mapped. As a result, each of the crushing elements is received and stored in data format by means of the radar unit, and the control unit respectively. The scanning and monitoring of the crushing elements can also be performed by an interferometry measurement using a first stationary radar and at least one angled radar. The arrangement of a stationary radar and an angled radar can form a radar unit which unit is arranged multiple times.

According to yet another embodiment, the rolls feature roller edge protection elements, whereas the monitoring of the condition of the at least one roll comprises the roller edge protection elements, and the radar beam also scans the roller edge protection elements. The condition and state of the edge protection elements is also mapped and stored as it is possible in conjunction with the crushing elements.

The implementing of the geometric data of the crushing elements on the outer surface of the roll in the good, new condition can be performed in different ways. As a first embodiment the implementing is performed by scanning new, unused impact elements, in order to detect the original shape and length of the impact elements extending above the surface of the roll. As an alternative and as a second embodiment, the implementing of the geometric data can be performed by programming the control unit or a storage. The storage can be a part of the control unit or the storage forms an exchangeable storage element.

The monitoring is performed via an online monitoring system—also referred as cloud based, by means of which the monitoring information can be transferred by wire, by internet, by GSM technique, by Bluetooth, NFC-technique or by any other transmitting technology to a peripheral monitoring control unit. The monitoring control unit can be located at another place relative to the place where the roller machine with the at least one the radar monitoring unit is located. This enables a supervisor or a supervising company to perform a remote monitoring of the condition of the crushing elements, the outer surface of the roll and/or the roller edge protection elements.

Furthermore, the invention relates to a monitoring unit for an implementation in a roller machine according to the description above, whereas the monitoring unit comprises at least one radar unit which is performed to radiate a radar beam onto the outer surface of the roll, whereas a control unit is provided to control the at least one radar unit and to evaluate the radar beam reflected from crushing elements and/or the surface of the roll to provide a monitoring of the state and the condition of the crushing elements. The state and the condition of the crushing elements comprises also a total absence or only a damage or an abrasive wearing of the surface. Due to occurring wear during operation of the roll crusher potholes or washout pockets can develop at the surface of the roll, and thus the surface of the roll can deviate from a cylindrical surface. This deviation can also be measured and mapped by the radar unit. The roller machine and in particular the applied radar unit is formed in such a way that the monitoring of the surface of the roll, an autogenous layer and/or the roller edge protection elements can be performed in the same manner as described above.

The radar unit forms an assembly of multiple radar elements as an array and/or in particular a configuration allowing synthetic aperture radar and optional interferometric SAR processing in one or more elements only observing a fraction of the roll, and/or the radar unit features a multistatic width, which is aligned to the width of the rolls. The multistatic width can be generated by a number of radars and in particular a number of radar antennas arranged in a line or a row or double row, which corresponds to the width W of the rolls and which line or row or double row is parallel arranged to the axis direction of the rolls. In another embodiment, antenna arrays or antenna clusters can be applied to scan the roller surface, whereas transmitters and receivers of the radar unit can be independent from another.

The preferred radar frequency of the radar unit amounts in the range 50 GHz to 1 THz to provide advantageous monitoring data. In particular the radar frequency can range between 50 GHz to 300 GHz, this causes a high bundling of radar beams and smaller antennas, and the radar does not go through the material of the roll and the crushing elements, but only scans its surface. If, for example, the roll has a diameter of 2000 mm, the circumference is about 6300 mm. When the roll is for example operated with 0.5 rev/sec, and the radar sampling frequency is 1000 Hz, the spacing between each sample is 3 mm. Measurement accuracies are possible even below 1 mm, especially when the radar signal sampling frequency is increased to 5000 Hz or even more. This is smaller than the diameter or main measurement of a crushing element, and thus the radar sampling enables to determine the condition of the crushing elements. As a result, it becomes possible to monitor the condition of the crushing elements with high accuracy and each single crushing element can be monitored and documented. The distance of the radar unit and the antenna respectively, to the crushing elements, to the surface of the roll and/or to the autogenous layer is in the rage of about 20 mm to 2000 mm.

### BRIEF DESCRIPTION OF THE DRAWINGS

Additional details, characteristics, and advantages of the object of the invention are disclosed in the following description of the respective figures. It is shown in

FIG. 1 is a view of a roller machine, embodied as a roller crusher with two rolls, and a first application of radar units is shown;

FIG. 2 is a schematic view of a roller machine with two rolls and with a schematic view of another application of a radar unit;

FIG. 3 is a schematic side view of a roll, and a radar unit which is applied above the roll;

FIG. 4 is a schematic view of the monitoring method of the crushing elements and the edge protection elements on the surface of the roll as well as the autogenous layer between crushing elements by means of a radar unit;

FIG. 5 the mounting of a radar unit in the crusher frame of the roller crusher by means of a maintenance removing system;

FIG. 6 is a more detailed view of single radar elements forming the radar unit, whereas the radar elements are directed perpendicular to the surface of the crusher roll;

FIG. 7 is a view of a single radar element forming the radar unit, whereas the radar element is arranged on the moving part of a scanner unit for travelling along the axial direction;

FIG. 8 is a view of single radar elements forming the radar unit, whereas the radar elements are angled relative to the surface of the crusher roll to form an SAR arrangement;

FIG. 9 an embodiment of single radar elements in an SAR arrangement forming the radar unit, whereas the radar elements are arranged on the moving part of a scanner unit for travelling along the axial direction; and

FIG. 10 two radar units at the outer sides of the crusher roll with two radar elements of each radar unit.

### DETAILED DESCRIPTION OF THE INVENTION

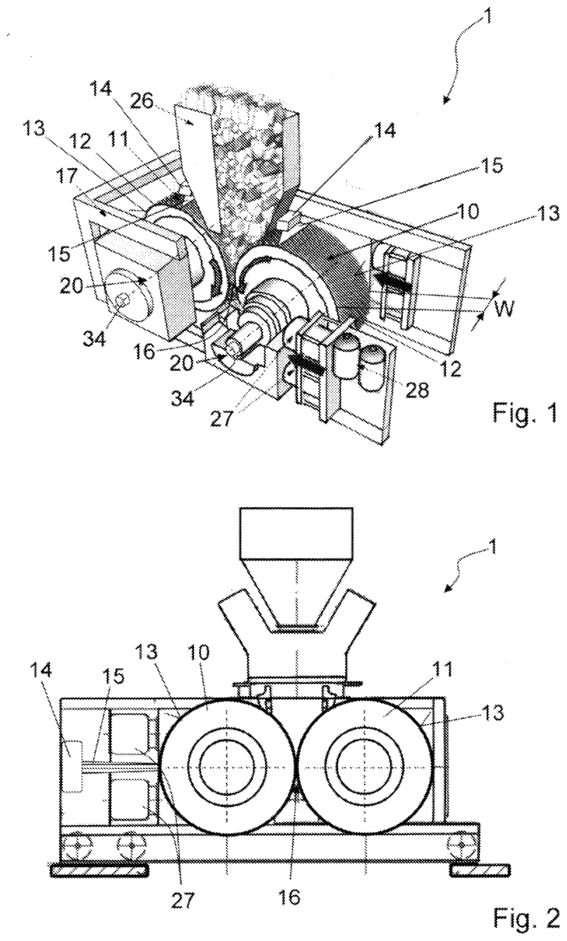

In FIG. 1 is depicted a schematic view of a roller machine 1, performed as a roller crusher with two rolls 10, 11, whereas the rolls 10, 11 feature a plurality of impact elements 12 on their outer surface 13.

The rolls 10, 11 are arranged parallel to each other, and the axis directions 20 represent the rotating axis of the rolls 10, 11. The rolls 10, 11 rotate about the rotating axis shown as axis directions 20 with opposite rotating directions as according to depicted arrows on the side faces of the rolls 10, 11.

In between the rolls 10, 11 a crushing gap 16 is formed, into which the crusher feed material 25 is applied, and the material 25 is feed by a chute 26 to the crushing gap 16.

The here backmost roll 10 is received in a fixed, rotatable manner within the crusher frame 17, and the here front roll 11 is received movable within the crusher frame 17. The front roll 11 is forced against the back most roll 10 by means of a forcing unit 27. The forcing unit 27 comprises a nitrogen system 28, by means of which the front roll 11 is stressed against the back most roll 10 to crush the feed material.

In the upper, top positions of the rolls 10, 11 radar units 14 are arranged according to the invention, and the radar units 14 provide a radar beam 15 onto the outer surface 13 of the rolls 10, 11. The radar beam 15 features a longitudinal extension in the axis direction 20, in order to irradiate the radar beam 15 across the entire width W of the rolls 10, 11 in the axis direction 20.

When the rolls 10, 11 are rotating in axial direction 20, and the radar beam 15 is performed to scan the outer surface 13 about the total width W of the rolls 10, 11, the entire development of the outer surface 13, thus the entire number of crushing elements 12 and the entire edge protection elements 23 are mapped by means of the radar unit 14.

The scanning by the radar beam 15 is performed by a scanner unit 19 to move the radar along the length of the roll 10, 11 or the radar unit is formed as a monostatic, a bistatic and/or a multistatic radar unit, having a number of radar units arranged in a row to form a line scanning radar, a so-called SAR, a synthetic aperture radar. In particular in conjunction with the radar array an interferometry measurement system can be added. In particular, the rather simple approach of simply measuring a small simple radar perpendicular to the roller every few cm, again as a double series can be applied.

The embodiment shows the position of the radar units 14 in the top position of the rolls 10, 11, and the radar beam 15 is directed in a vertical direction onto the outer surface 13 of the rolls 10, 11.

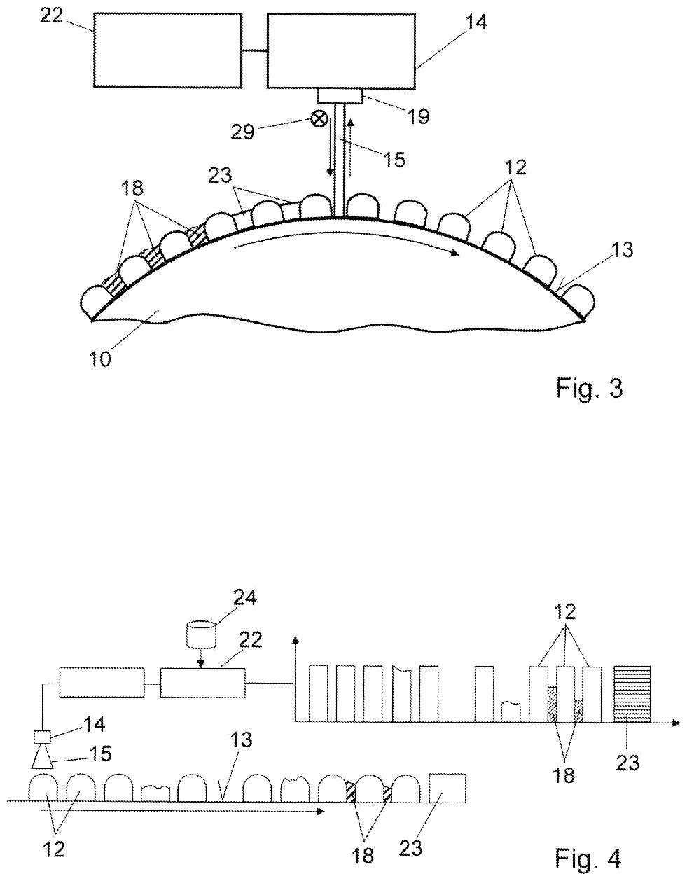

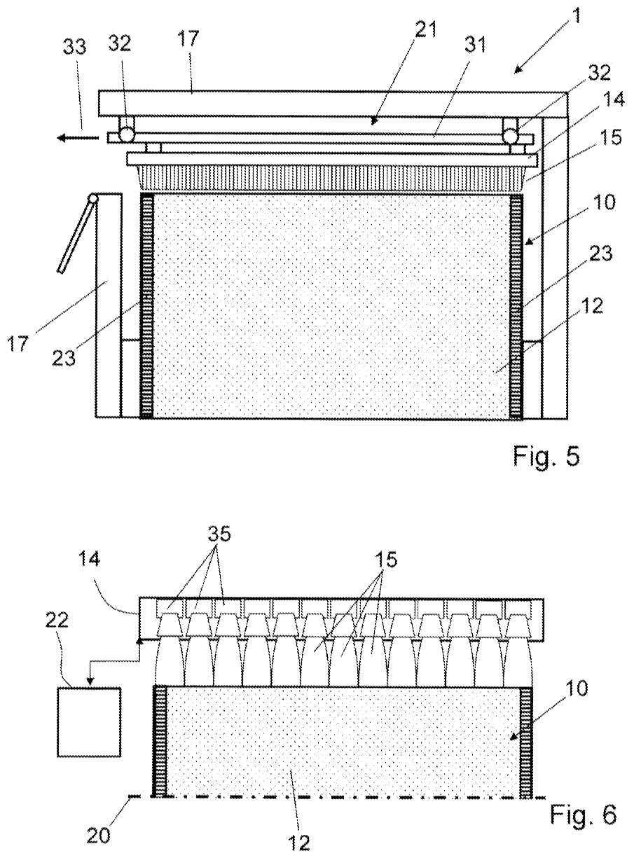

In attachment to the axis, numbered with the axial direction 20, are applied rotation angular encoders 34 at each roll 10, 11, in order to provide a rotation angle value of the rolls 10, 11 about the rotation axis. This enables a control unit 22, refer to FIG. 3 or FIG. 4, to identify each single crushing element 12 across the entire surface 13 of the roll 10, 11. This leads to the advantage that the condition and/or wear of each single crushing element 12 can be identified, monitored, and documented. The same is applicable to the roller edge protection elements 23, refer to FIG. 4 and FIG. 5.

FIG. 2 shows an alternative embodiment of a roller machine 1, embodied as a roller crusher with a crusher frame 17 which carries a first roll 10 and a second roll 11. The hydraulic cylinders 27 are shown on the left side, and a radar unit 14 is exemplarily shown in a position diametral to the crushing gap 16 in between the rolls 10, 11. The radar beam 15 is directed to the outer surface 13 of the first roll 10. With the same arrangement the second roll 11 can also be monitored by means of a radar beam provided by another radar unit 14 on the right side of the roll 11, which is not shown.

FIG. 3 shows a schematic view of the upper part of the rolls 10, and the radar unit 14 is arranged above the roll 10. The radar unit 14 features a linear actor in the form of a scanner unit 19 to move the radar beam 15 in the displacement direction 29 perpendicular to the image plane, whereas the displacement direction 29 falls together with the axis direction 20 for rotating the roll 10, refer to FIG. 1.

On the surface 13 of the roll 10 a number of crushing elements 12 are applied, which have to be monitored by the radar unit 14. Next to the radar unit 14 a control unit 22 is shown, by which the radar unit 14 is operated and in which the received data about the crushing elements 12, the outer roll surface 13, the roller edge protection elements 23 and the autogenous layer 18 can be calculated and the condition of the crushing elements 12 the outer roll surface 13 and the autogenous layer 18 can be determined. Further, the control unit 22 enables the identification of the presence of the crushing elements 12 as well as the state and condition of the crushing elements 12, e. g. the length of the crushing elements 12 above the outer surface 13 of the roll 10. Due to the rotating movement of the roll 10, refer to the arrow as depicted, one crushing element 12 after the other runs through the radar beam 15. The determination of the presence, the state and the condition of the crushing elements 12 is based on the measurement by the radar beam 15, which is reflected by the crushing elements 12, shown by a first and a second arrow for the radiation of the radar beam 15 onto the crushing elements 12 and the reflecting radar beam 15 back to the radar unit 14.

In between the crushing elements 12 an autogenous layer 18 can be established, which can be monitored as well by means of the radar unit 14. The same monitoring is applicable to the roller edge protection elements 23.

FIG. 4 shows a schematic view of the monitoring principle by means of the radar unit 14, which is performed to direct a radar beam 15 onto the outer surface 13 of a roll 10, 11. On the outer surface 13 a number of crushing elements 12 is applied, which can be damaged, or which can be missing. When the radar unit 14 monitors the crushing elements 12, the radar unit 14 is operated by a control unit 22. In the sense of the invention, the radar unit 14 can comprise the entire radar system or can only be represented by a radar antenna. The control unit 22 is followed by an evaluation unit to evaluate the received radar beam 15 and to transform the information of the radar beam 15 into a geometric information of the state and the condition of the crushing elements 12.

As a result, the exemplary shown diagram can carry out a computer readable diagram with a graphical depiction of the condition of the crushing elements 12. The single beams depicted in the diagram represent single crushing elements 12, which are only shown in an exemplary fashion, and which show only one possible graphical depiction of the condition of the crushing elements 12. In the storage unit 24 the measuring data are stored. Additionally, the condition and the wear history of the crushing elements 12 can be stored in the storage unit 24.

In between the crushing elements 12 an autogenous layer 18 can be formed during the operation of the roller machine, which can also be depicted in the diagram. In the same way as the monitoring of the crushing elements 12, the outer surface of the roll 13 and the roller edge protection elements 23 can be monitored. According to another advantage in this context a person can distinguish between the crushing elements 12, the outer surface 13 and the roller edge protection elements 23, whilst observing the diagram e.g., at a monitor.

Finally, FIG. 5 shows a maintenance removing system 21 which carries the radar unit 14, which is shown with the radar beam 15 above the crushing rolls 10 within the crusher frame 17. The maintenance removing system 21 comprises a gliding system 31, exemplarily shown with gliding rolls 32, to enable the radar unit 14 to be telescopically moved out of the frame 17, shown by a lateral arrow, which represents the removing direction 33.

The depiction in FIG. 5 also shows roller edge protection elements 23 at the outer edges of the cylindrical roll 10, whereas the crushing elements 12 are positioned on the shell surface in between the roller edge protection elements 23. The radar unit 14 is designed to monitor or to measure the state and the condition of the roller edge protection elements 23 in the same way as it is taught in conjunction with the crushing elements 12.

FIG. 6 shows a more detailed view of a radar unit 14 having a number of radar elements 35 arranged in a common row for providing an elongated radar beam 15, which consists of a number of single radar beams 15 positioned one next to each other along the axis direction 20. The radar beams 15 are directed perpendicular onto the surface of the crusher roll 10. The radar unit 14 comprising the number of single radar elements 35 is controlled by the control unit 22. This arrangement enables the scan of the surface of the crusher roll 10 in the axis direction 20, and when the crusher roll 10 is running about the axis in the axis direction 20, the entire surface of the crusher roll 10 can be scanned with only one revolution about the rotating axis and the huge number of crushing elements 12 can be analyzed. The radar unit 14 can for example be attached to the crusher frame 17 of the roller crusher 1.

As an example only, each radar element 35 can generate a radar beam 15 having a diameter of about 50 mm, and e.g. 20 radar elements 35 are arranged on the length of 1 m extension along the axis direction 20. When the crusher roll 10 features a length of 2.5 m, in total 50 radar elements 35 are arranged in one common row along the axis direction 20 whereas the radar beam 15 is directed perpendicular to the shell surface of the crusher roll 10.

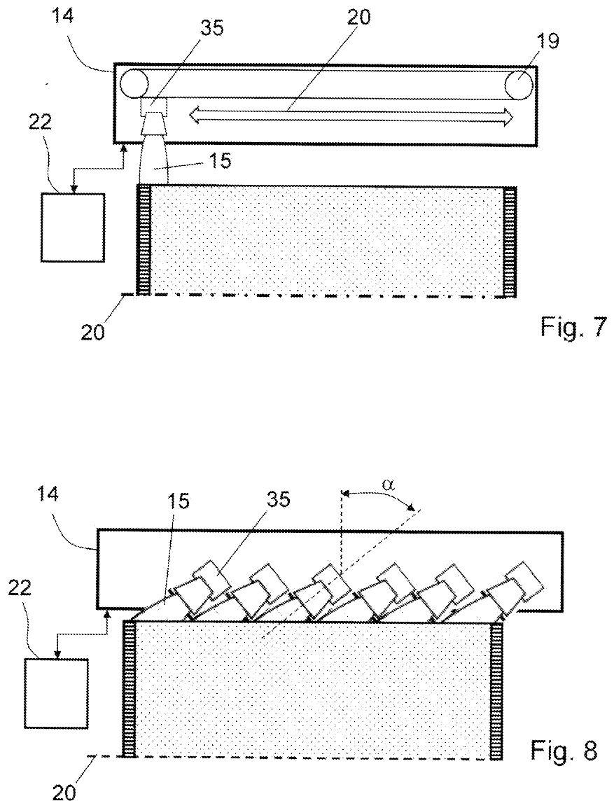

FIG. 7 depicts another embodiment of the laser unit 14, which laser unit 14 features only one single radar element 35. This single radar element 35 is mounted to a movable part of a scanner unit 19, so that the single radar element 35 can travel above the surface of the crusher roll 10 along the axis direction 20. The control of the radar unit 14 and the scanner unit 19 is performed by the control unit 22. When the crusher roll 10 is running about its rotation axis represented by the axis direction 20, the scanner unit 19 can displace the radar element 35 step by step, while the radar element 35 pauses at certain axial positions, at least as long as the crusher roll 10 fulfils at least one revolution about the rotation axis. After scanning the entire circumference of the crusher roll 10 in said certain axial position, the scanner unit 19 displaces the radar element 35 to a next axial position and pauses again, until the roll 10 has performed at least one revolution again. In this way, the single radar element 35 is able to scan the entire shell surface of the roll 10 until the movable part of the scanner unit 19 arrives at the outer edge of the roll 10. In this position, the movable part of the scanner 10 travels in the opposite direction again and the step by step scanning process can be repeated. This arrangement makes necessary to provide a scanner unit 19, but it is still only one single radar element 35 necessary to scan the entire shell surface of the roll 10, whereas the radar beam 15 is directed perpendicular to the shell surface of the crusher roll 10.

The more data are collected the better is the resolution of the surface imaging. Due to roll rotation of the crusher roll 10 and the linear scanner unit 19, the number of measurement points is just limited by the axis step wide and the rotation angle measurement accuracy.

In FIG. 8 is shown an arrangement of a certain number of single radar elements 35 that are aligned under an angle a relative to a direction perpendicular to the shell surface of the crusher roll 10, and thus the angle a is measured between the main axis of the radar beam 15 and the perpendicular direction onto the surface of the crusher roll 10 and thus perpendicular to the axis direction 20. As an example only, the angle a amounts about 15° to 85°. In this arrangement of the number of single radar elements 35 the so-called SAR imaging setup is realized. The SAR radar measurement describes a so called synthetic aperture radar, and such a SAR is a form of radar system that is used to create two-dimensional images or three-dimensional reconstruction images of objects on a surface, so that the crushing elements can be imaged as well as the surface itself or a autogenous layer. SAR radars use the motion of the radar antenna over a target region to provide finer spatial resolution than conventional stationary beam-scanning radars. The motion can be realized by the rotation movement of the crusher roll 10 and thus of its shell surface relative to the radar beams 15. In this way, the SAR principle can be realized without moving the single radar elements 35. The radar unit 14 comprising the number of single radar elements 35 is controlled by the control unit 22.

The single radar elements 35 can also be arranges in an array featuring more than one row, and radar frequency can e.g. amount about 120 GHz to 140 GHz. This arrangement needs less single radar elements 35, for example not 20 per meter according to the arrangement shown in FIG. 6 but a number of not more than 5 to 6 single radar elements 35 per meter. And in case that there is only little space on the side of the crusher roll 10, that setup is better than other linear actuator setups.

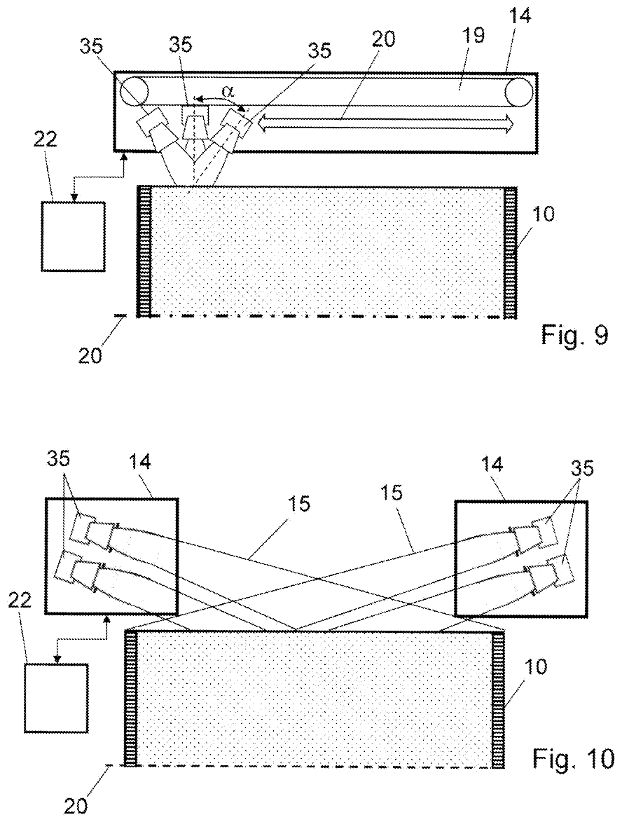

FIG. 9 shows an embodiment with three radar elements 35 forming the radar unit 14 in an exemplary fashion, which are received by a scanner unit 19 to travel the radar elements 35 along the surface of the crusher roll 10 in the axis direction 20. These radar elements 35 form a multistatic array, by which a high radar bandwidth is required. The central vertical radar elements 35 is taught for a simple distance measurement, detecting the roll distance, and the two inclined radar elements 35 represent the SAR radars. In such a way both sides of the crusher roll 10 entirely can be measured, and the array is moved along the linear axis 20, in e.g. 20 cm steps.

This embodiment combines the use of the scanner unit 19 to displace the radar elements 35 in the axis direction 20 with the arrangement of the SAR radar. The necessary movement of the scanned surface relative to the radar elements 35 in the SAR arrangement is the travelling of the radar elements 35 along the axis direction 20 by means of the scanner unit 19 and additionally the rotation of the crusher roll 10, that means that the shell surface of the crusher roll 10 moves relative to the radar elements 35, whereas the travelling of the radar elements 35 along the axis direction 20 is a movement which is perpendicular to the shell surface movement caused by the rotation of the crusher roll 10 about the rotation axis in the axis direction 20. The radar unit 14 comprising the number of single radar elements 35 and the processing of the SAR radar imaging is controlled by the control unit 22.

Finally, FIG. 10 shows an embodiment in which at each side of the crusher roll 10 are arranged two radar elements 35 each forming one radar unit 14. This arrangement forms a fixed, interferometric high resolution SAR Imaging radar unit 14. When only one radar unit 14 would be arranged at one side of the crusher roll 10, the required radial distance of the radar unit 14 to the crusher roll 10 might be quite large to allow the purple line to fit to the shell surface of the crusher roll 10. But when at both sides of the crusher rolls 10 are arranged radar units 14, the radial distance can be decreased.

### LIST OF NUMERALS

1 roller machine
10 roll
11 roll
12 crushing element
13 outer surface of the roll
14 radar unit
15 radar beam
16 crushing gap
17 crusher frame
18 autogenous layer
19 scanner unit
20 axis direction
21 maintenance removing system
22 control unit
23 roller edge protection element
24 storage unit
25 crusher feed material
26 chute
27 hydraulic cylinders
28 nitrogen system
29 displacement direction
30 evaluation unit
31 gliding system
32 gliding rolls
33 removing direction
34 rotation angular encoder
35 radar element
W width
a angle
SAR Synthetic Aperture Radar

1-17. (canceled)

18. A roller Machine for crushing or compacting feed material, comprising:
at least one roll having a plurality of crushing elements and/or edge protection elements on an outer surface of the at least one roll;
at least one radar unit operable to emit a radar beam onto the outer surface of the at least one roll, in order to monitor a condition of the crushing elements and/or of the edge protection elements on the outer surface by measurement by the radar beam reflected at least by the crushing elements and/or of the edge protection elements.

19. The roller Machine according to claim 18, wherein:
the at least one roll comprises a first roll and a second roll;
the at least one radar unit comprises a first radar unit operable to direct a first radar beam onto the outer surface of the first roll and a second radar unit operable to direct a second radar beam onto the outer surface of the second roll.

20. The roller Machine according to claim 19, wherein a crushing gap is defined between the first roll and the second roll and the first radar unit and/or the second radar unit are positioned spaced apart from the gap.

21. The roller Machine according to claim 19, further comprising:
a crusher frame, in which the first and second roll are rotatable received;
the first radar unit and/or a second radar unit arranged within the crusher frame in a top position 90° rotated to the crushing gap or at a lateral outer side 180° diametral to the crushing gap or at any position in between the 90° position and the 180° position.

22. The roller Machine according to claim 18, wherein:
the crushing elements are formed by stud elements extending above the outer surface of the at least one roll; and
the at least one radar unit is operable to measure a presence and/or a height of the stud elements extending above the outer surface.

23. The roller Machine according to claim 18, wherein an autogenous layer is formed in between the crushing elements from the crushing process, the at least one radar unit being operable to measure a thickness of the autogenous layer above the outer surface of the at least one roll.

24. The roller Machine according to claim 18, wherein the at least one radar unit features a monostatic, bistatic or a multistatic antenna layout.

25. The roller Machine according to claim 18, wherein the at least one radar unit is operated in a FMCW modulation or a pulse modulation and/or the at least one radar unit features a standard signal processing and/or a Synthetic Aperture Radar (SAR) and/or an interferometric SAR.

26. The roller Machine according to claim 19, wherein the first radar unit and/or the second radar unit forms a multistatic radar sensor or bistatic or a monostatic radar sensor with a scanner unit to scan the radar beam across the outer surface of the respective roll in an axis direction, in particular across an entire width of the respective roll, while the outer surface is circumferentially moved due to the rotating of the respective roll about the axis direction.

27. The roller Machine according to claim 21, wherein the at least one radar unit is received in a maintenance removing system, by which the radar unit can easily be removed out of the crusher frame, in particular by a sliding movement.

28. A method for monitoring a state of a roller machine for crusher feed material according to claim 18, comprising at least the following steps:
providing a control unit, wherein the control unit controls the at least one radar unit;
implementing geometric data of the crushing element on the outer surface of the at least one roll, whereas the geometric data relate to crushing elements in good and/or new condition; and
measuring a condition of the crushing elements and/or the outer surface of the at least one roll and/or the edge protection elements and/or an autogenous layer by measurement by the radar beam reflected at least by the crushing elements to monitor a state of the crushing elements.

29. The method according to claim 28, further comprising:
the control unit controls the at least one radar unit for mapping the geometric data of the plurality of crushing elements while the roller machine is in operation and the at least one roll is turning; and
comparing the measured geometric data of the plurality of crushing elements with the geometric data of the crushing elements in their good and/or new condition; and
providing a condition value of the crushing elements based on a difference of the actual measured geometric data compared to the geometric data of the crushing elements in their good and/or new condition.

30. The method according to claim 28, wherein the measuring of the condition of the crushing elements is performed by scanning of the crushing elements by the radar beam during the turning of the roll, whereas the scanning is performed in an axis direction of the roll by a scanner unit or a multiple monostatic, bistatic or multistatic radar.

31. The method according to claim 28, wherein the at least one roll include the roller edge protection elements, whereas the monitoring of the condition of the at least one roll comprises monitoring of the roller edge protection elements, and the radar beam is also moved and/or arranged over the roller edge protection elements.

32. The method according to claim 28, wherein the monitoring is performed via an online monitoring system, by which the monitoring information can be transferred by wire, by internet, by GSM technique, by NFC-technique or by any other transmitting technique to a peripheral monitoring control unit.

33. A monitoring unit for implementation into a roller machine according to claim 18, the monitoring using operable to perform a method comprising at least the steps of:
implementing geometric data of the crushing element on the outer surface of the at least one roll, whereas the geometric data relate to crushing elements in good and/or new condition; and
measuring a condition of the crushing elements and/or the outer surface of the at least one roll and/or the edge protection elements and/or an autogenous layer by measurement by the radar beam reflected at least by the crushing elements to monitor a state of the crushing elements;
wherein the monitoring unit comprises the at least one radar unit operable to radiate the radar beam onto the outer surface;
wherein a control unit is provided to control the at least one radar unit and to evaluate the radar beam reflected from crushing elements and/or the surface of the at least one roll and/or the edge protection elements and/or a autogenous layer between the crushing elements to provide a monitoring of a condition of the crushing elements and/or the edge protection elements and/or the outer surface of the at least one roll and or the autogenous layer between the crushing elements.

34. The monitoring unit according to claim 33, wherein the at least one radar unit forms a multiple monostatic, bistatic or multistatic radar unit and/or in particular a synthetic aperture radar unit, and/or the at least one radar unit features a multistatic width, which is aligned to a width (W) of the at least one roll.
